(19) United States
(12) Patent Application Publication
(10) Pub. No.: US 2013/0168039 A1
(43) Pub. Date: Jul. 4, 2013

(54) AIR GUIDE STRUCTURE OF RADIATOR IN STRADDLE VEHICLE

(71) Applicant: Kawasaki Jukogyo Kabushiki Kaisha, Kobe-shi (JP)

(72) Inventors: Kozo Arai, Kobe-shi (JP); Kenji Hashizume, Kobe-shi (JP); Yuuki Yamashita, Kakogawa-shi (JP); Kenichi Nishimura, Kitakatsuragi-gun (JP)

(73) Assignee: KAWASAKI JUKOGYO KABUSHIKI KAISHA, Kobe-shi (JP)

(21) Appl. No.: 13/719,126

(22) Filed: Dec. 18, 2012

(30) Foreign Application Priority Data
Dec. 28, 2011 (JP) 2011-287553

(51) Int. Cl. B60H 1/00

(52) U.S. Cl. CPC B60H 1/00021
USPC 165/41; 165/121

(57) ABSTRACT

An air guide structure of a radiator built into a straddle vehicle which exchanges heat between a cooling medium of a driving power source and ram air to release heat from the cooling medium. The air guide structure includes an electric fan provided at a core of the radiator such that it is disposed in close proximity to the core at a downstream side in a flow direction of the ram air, and a shroud provided to cover the electric fan from the downstream side and cover the electric fan from above and from both lateral sides, the shroud being open in a downward direction. The core of the radiator is provided with a ram air passage region outside of a portion of the core which is covered with the shroud when viewed in the flow direction of the ram air travelling through the ram air passage region.

### BACKGROUND OF THE INVENTION

1. Field of the Invention

The present invention generally relates to an air guide structure of a radiator mounted in a straddle vehicle such as a motorcycle.

2. Description of the Related Art

Conventionally, in a case where a water-cooled engine is mounted in a straddle vehicle such as a motorcycle, a radiator is disposed forward relative to the engine to facilitate heat release from cooling water for cooling the engine, and an electric fan is mounted behind and in close proximity to the radiator. When ram air is slow during, for example, low-speed driving, the electric fan suctions the ram air out of the radiator. For example, Japanese Laid-Open Patent Application Publication No. 2001-90536 discloses a motorcycle in which an engine running state as well as a cooling water temperature are controlled, thereby actuating an electric fan more appropriately.

However, in this motorcycle, since the electric fan is disposed in a narrow space between the engine and the radiator, heated air radiated from the electric fan collides against the engine and disperses in four directions. Typically, the electric fan is activated when the ram air is slow, such as conditions in which low-speed driving and temporary stopping are repeated in traffic congestion. In this situation, the heated air released from the engine might make a driver or a passenger feel discomfort.

The above conventional motorcycle is covered with a cowling from a front portion of a vehicle body to a region near the engine. The heated air blowing out of the electric fan and dispersing in four directions tends to stay inside of the cowling, which may negatively affect components built into the motorcycle.

### SUMMARY OF THE INVENTION

The present invention addresses the above described conditions, and the object of the present invention is to provide an air guide structure for guiding heated air from an electric fan such that the heated air does not substantially stay inside of a cowling, thereby preventing a driver or a passenger from feeling discomfort due to the heated air.

According to an aspect of the present invention, there is provided an air guide structure of a radiator which is built into a straddle vehicle and exchanges heat between a cooling medium of a driving power source and ram air to release heat from the cooling medium. The air guide structure comprises an electric fan provided at a core of the radiator such that the electric fan is disposed in close proximity to the core of the radiator at a downstream side of the radiator in a flow direction of the ram air and a shroud provided to cover the electric fan from the downstream side and cover the electric fan from above and from both lateral sides, the shroud being open in a downward direction, wherein the core of the radiator is provided with a ram air passage region outside of a portion of the core which is covered with the shroud when viewed in the flow direction of the ram air, the ram air travelling through the ram air passage region.

In accordance with this configuration, the electric fan attached to the radiator is covered with the shroud from above to both lateral sides, and the shroud opens in the downward direction. For example, when the electric fan is actuated during low-speed driving in traffic congestion, the heated air suctioned out of the core of the radiator blows out in the downward direction. Therefore, a driver or a passenger riding on the straddle vehicle is not exposed to the heated air and does not feel discomfort due to the heated air. In a straddle vehicle including a cowling, the heated air does not substantially stay inside of the cowling and will not negatively affect components built into the straddle vehicle.

In addition, the core of the radiator is not entirely covered with the shroud, but the ram air passage region through which the ram air passes easily is provided outside of the shroud in the flow direction of the ram air. Therefore, an increase in resistance to the flow of the ram air which would be caused by the shroud can be suppressed even when high-speed ram air is applied to the straddle vehicle during medium-speed driving or high-speed driving.

The electric fan may be mounted to the shroud. In this configuration, the number of components and the number of assembling steps are lesser than a configuration in which a mounting (support) member for mounting (supporting) the electric fan to the radiator is provided additionally.

The radiator may be disposed forward relative to the driving power source to allow the ram air to travel through the radiator in a forward and rearward direction of the straddle vehicle. In this case, preferably, at least a half portion of the ram air passage region of the core of the radiator may not overlap with the driving power source when viewed in the flow direction of the ram air. This allows the ram air to easily travel through the ram air passage region.

The radiator may be inclined in a forward direction such that its upper portion is forward relative to its lower portion. This makes it possible to design the ram air passage region so that the ram air travels upward in the rearward direction and above the driving power source. The heated air blows out in the downward direction and in an obliquely rearward direction through the opening of the shroud and then travels in a rearward direction through a region below the driving power source, which further lessens a possibility that the driver or the passenger feels discomfort due to the heated air.

The radiator may have a rectangular shape which is elongated in a rightward and leftward direction of the straddle vehicle and the shroud may have in an upper portion thereof a circular-arc upper wall portion enclosing a periphery of the electric fan, a pair of right and left side walls extending from right and left ends of the upper wall portion such that the side wall portions extend downward and outward in the rightward and leftward direction, and a rear wall portion covering the electric fan from a rear.

In this configuration, since the pair of right and left side walls extend downward and outward in the rightward and leftward direction, a cross-sectional area of a flow passage for guiding in a downward direction the heated air from the electric fan can be increased gradually in the rightward and leftward direction. This makes it possible to guide heated air with a great amount smoothly in the downward direction. Since a dimension of the upper portion of the shroud in the rightward and leftward direction is small, the ram air passage regions can be provided in the core of the radiator at right and left sides of the upper portion of the shroud. After travelling through the right and left ram air passage regions, the ram air travels in the rearward direction through regions above, below, rightward, and leftward, relative to the driving power source positioned behind the radiator.

The shroud may have a rear wall portion covering the electric fan from a rear and protruding portions protruding forward from the rear wall portion may extend vertically to be apart from right and left ends of the electric fan such that the protruding portions are apart from each other in the rightward and leftward direction when viewed in the flow direction of the ram air. This allows the heated air to travel in the downward direction between the right and left protruding portions, even when the amount of the ram air is small.

A dimension of the shroud in the forward and rearward direction may increase gradually from an upper side to a lower side. In this configuration, the cross-sectional area of the passage for guiding in the downward direction the heated air from the electric fan increases gradually in the forward and rearward direction. Therefore, the heated air from the electric fan travels smoothly in the downward direction regardless of whether the amount of the ram air is small or large.

The air guide structure of the radiator may comprise a seal member provided between an upper portion of the shroud and the radiator. In this configuration, even when the straddle vehicle is in a stopped state after driving and the electric fan is not activated, the heated air is prevented from leaking upward.

According to another aspect to the present invention, there is provided an air guide structure of a radiator which is built into a straddle vehicle, and exchanges heat between a cooling medium of a driving power source and ram air to release heat from the cooling medium. The air guide structure comprises a guide member which is disposed rearward in a flow direction of the ram air relative to a heat exchange section of the radiator and guides the ram air in an outward direction of the vehicle after the ram air has passed through the heat exchange section of the radiator.

In accordance with this configuration, since the guide member disposed rearward in the flow direction of the ram air relative to the heat exchange section of the radiator guides the ram air in the outward direction of the vehicle after the ram air has passed through the heat exchange section, heated air does not substantially stay inside of the vehicle and will not negatively affect components mounted in the vehicle. The heat exchange section may be a radiator core. The guide member may be a shroud.

The air guide structure of the radiator may further comprise a fan which is disposed rearward in the flow direction of the ram air relative to the heat exchange section of the radiator and causes the ram air to pass through the heat exchange section such that the ram air is guided from forward of the heat exchange section to rearward of the heat exchange section, wherein the guide member may guide the ram air flowing out of the fan in the outward direction of the vehicle. This makes it possible to prevent the ram air heated by the heat exchange in the radiator from staying in the vicinity of the vehicle.

The guide member may have an opposed surface positioned rearward in the flow direction of the ram air so as to face the heat exchange section of the radiator and a guide surface extending in a forward and rearward direction so as to surround the opposed surface. The opposed surface and the guide surface form a guide surface for guiding the ram air, and the opposed surface may be inclined in a forward direction with respect to a vertical direction. This makes it possible to prevent the opposed surface from becoming a resistance to the ram air traveling through the heat exchange section.

The guide member may guide the ram air in a downward direction. Since the ram air is guided to a space in this way, it is possible to prevent the heated air from staying inside of the vehicle. The opposed surface may be a surface of a rear wall portion of the guide member which faces the radiator, and the guide surface may be an inner surface of an upper wall portion and an inner surface of a side wall portion of the guide member.

The radiator and the guide member may be disposed forward in the flow direction of the ram air relative to a driving power source. Thus, the ram air is guided to the radiator without being blocked by the driving power source.

The driving power source may be an engine including a cylinder block, the cylinder block and the radiator may be inclined in a forward direction, and the guide member may guide the ram air along a direction in which the cylinder block and the radiator are inclined. Thus, the heated air is guided easily in the rearward direction during driving of the vehicle.

The above and further objects, features and advantages of the invention will more fully be apparent from the following detailed description with reference to the accompanying drawings.

### BRIEF DESCRIPTION OF THE DRAWINGS

FIG. 1 is a left side view of a motorcycle which is an exemplary straddle vehicle of the present invention.

FIG. 2 is an enlarged view showing a layout of an engine and a radiator, with a front cowling and other components detached from the motorcycle.

FIG. 3 is a perspective view of an assembly of the radiator, an electric fan and a shroud, when viewed from a front.

FIG. 4 is a perspective view of the assembly when viewed from a rear.

FIG. 5 is a perspective view of the assembly when viewed from below.

FIG. 6 is a schematic view showing a state in which ram air passage regions do not substantially overlap with the engine located behind the ram air passage regions, when a core of the radiator is seen in a flow direction of the ram air.

### DETAILED DESCRIPTION OF THE PREFERRED EMBODIMENTS

Hereinafter, an air guide structure of a radiator according to an embodiment of the present invention will be described with reference to the drawings. In the present embodiment, the radiator is mounted in a motorcycle which is an exemplary straddle vehicle. A rightward and leftward direction stated below is from the perspective of a driver straddling the motorcycle.

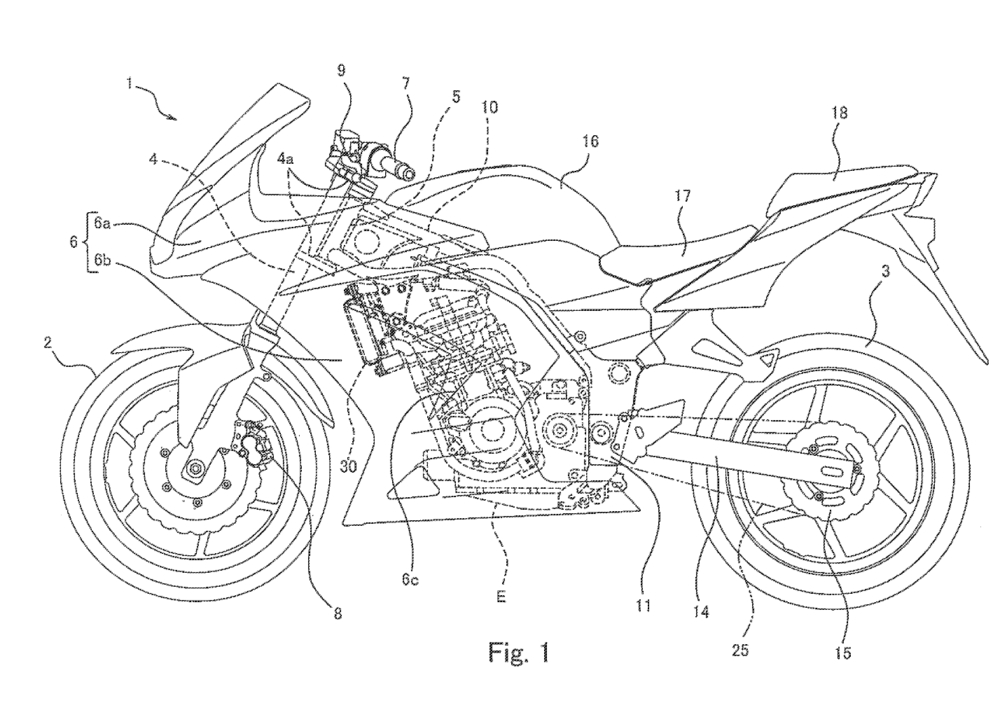

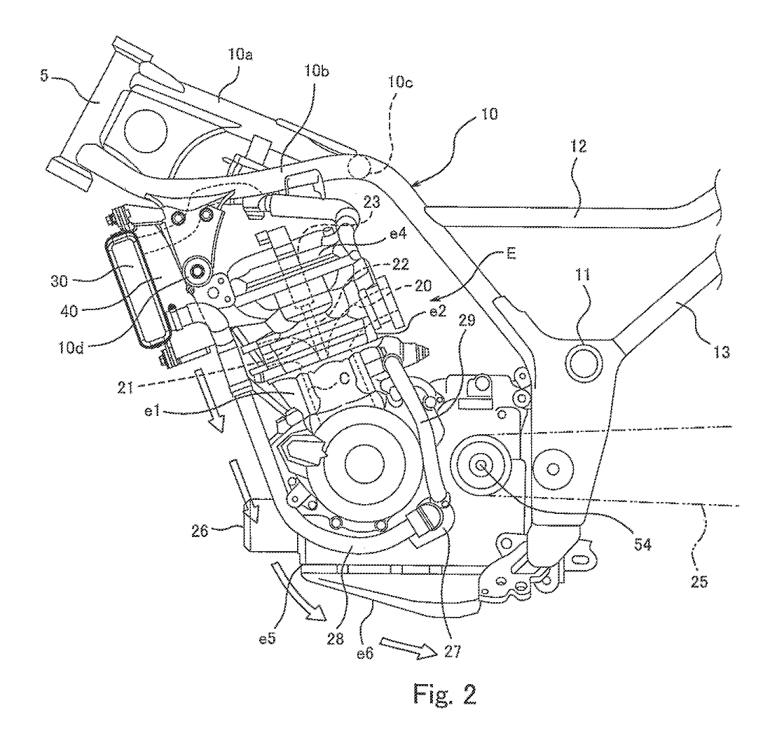

FIG. 1 is a left side view of a motorcycle 1 according to an embodiment of the present invention. As shown in FIG. 1, the motorcycle 1 includes a front wheel 2 which is a driven wheel and a rear wheel 3 which is a drive wheel. The front wheel 2 is rotatably mounted to a lower end portion of a front fork 4 extending vertically such that the front fork 4 is slightly inclined in a rearward direction. An upper portion of the front fork 4 is supported on a steering shaft (not shown) via a pair of upper and lower brackets 4a. The steering shaft is rotatably supported by a head pipe 5 (see FIG. 2) attached to a vehicle body of the motorcycle 1.

The motorcycle 1 of the present embodiment includes a full cowling 6 for surrounding the brackets 4a coupling the upper portion of the front fork 4 to the vehicle body, the steering shaft, the head pipe 5, and others, from forward and from right and left sides. The full cowling 6 is made of a resin. The full cowling 6 includes an upper cowling 6a attached to a windshield and a head lamp, and right and left lower cowlings 6b extending from right and left sides of the upper cowling 6a, downward and obliquely rearward and covering the right and left sides of the engine E. Ram air for cooling the engine E flows into the cowling 6 through a space between the upper cowling 6a and the front wheel 2 and flows out through openings at lower portions of the lower cowlings 6b and right and left slits 6c.

A separable handle 7 extending in a rightward and leftward direction is attached to the upper bracket 4a located at an upper end of the front fork 4. The driver manipulates the handle 7 to steer the front fork 4 and the front wheel 2 around the head pipe 5 (steering shaft). A front wheel brake 8 including a brake disc rotatable integrally with the front wheel 2 is disposed at a lower end portion of the front fork 4.

A throttle grip (not shown) gripped by a right hand of the driver is attached to the right handle 7. The driver rotates the throttle grip by twisting a wrist, to adjust a power output of the engine E. A brake lever is provided in front of the throttle grip to actuate the front wheel brake 8. The left handle 7 is attached with a clutch lever 9 in front of a grip gripped by a left hand of the driver.

As shown in FIG. 2, a main frame 10 extends rearward from the head pipe 5, with the full cowling 6 detached. In the present embodiment, a front portion of the main frame 10 includes a center frame member 10a and a pair of right and left side frame members 10b. The center frame member 10a is constituted by a round pipe extending rearward from the upper portion of the head pipe 5 such that the center frame member 10a is inclined slightly downward. The right and left side frame members 10b are constituted by round pipes extending rearward from the lower portion of the head pipe 5 to the right and to the left, respectively.

The right and left side frame members 10b extend rearward in such a manner that they are curved gradually and inclined slightly upward, are bent and are inclined downward. Bent portions of the right and left side frame members 10b are coupled together by means of a cross member 10c constituted by a round pipe. A rear end of the center frame member 10a is coupled to the cross member 10c. The head pipe 5, the center frame member 10a, the side frame members 10b and the cross member 10c make it possible to ensure a stiffness of the front portion of the main frame 10.

The right and left side frame members 10b are bent downward at the portions coupled together by means of the cross member 10c, and then extend linearly rearward and obliquely downward. Pivot frames 11 extending downward are coupled to rear ends of the right and left side frame members 10b, respectively. A pair of right and left rear side frames 12 extends rearward and substantially horizontally from portions in the vicinity of the bent portions of the right and left side frame members 10b. The rear side frames 12 and rear stays 13 extending rearward and obliquely upward from upper ends of the pivot frames 11 constitute a framework of a rear portion of the vehicle body of the motorcycle 1.

As shown in FIG. 1, front end portions of the swing arms 14 extending substantially in a forward and rearward direction are mounted to the pivot frames 11, respectively such that the swing arms 14 are pivotable around their front end portions, respectively. The rear wheel 3 is rotatably mounted to rear end portions of the swing arms 14. A chain 25 indicated by a virtual line is wrapped around a sprocket 15 of the rear wheel 3. As will be described later, a rotation output from a transmission is transmitted to the chain 25. A fuel tank 16 is disposed at an upper portion of the main frame 10. A straddle seat 17 for the driver (rider) is disposed behind the fuel tank 16. Behind the seat 17, a straddle rear seat 18 for a tandem rider is disposed.

As shown in FIG. 2, an engine E is mounted to the lower portion of the main frame 10 such that the engine E is supported by the main frame 10 and the pivot frames 11. In FIG. 2, an engine body is depicted in a state in which an air-intake system, an exhaust system and others are detached. For example, the engine E is an inline two-cylinder gasoline engine in which two cylinders C are arranged in the rightward and leftward direction. A cylinder head e2 is mounted to an upper portion of a cylinder block e1 provided with the two cylinders C to close upper ends of the cylinders C. A piston (not shown) is reciprocatingly inserted into each of the cylinders C, and a combustion chamber is formed thereabove.

As indicated by a broken line in FIG. 2, the cylinder head e2 is provided with an intake port 20 and an exhaust port 21 for each of the cylinders C each of which opens to a ceiling portion of the combustion chamber. The opening of the intake port 20 and the opening of the exhaust port 21 facing inside of the cylinder C are opened and closed by an intake valve and an exhaust valve actuated by an intake cam shaft and an exhaust cam shaft (not shown), respectively. For example, in the present embodiment, a DOHC valve driving mechanism including two camshafts, which are the intake camshaft and the exhaust camshaft, is provided, and a head cover e4 covers the cylinder head e4 from above.

The intake port 20 extends obliquely upward from the ceiling portion of the combustion chamber within each cylinder C and opens to a rear surface of the cylinder head e2. In a state in which the engine E is mounted in the motorcycle 1, the cylinder block e1 and the cylinder head e2 are inclined slightly forward. Two throttle bodies (not shown) are provided on a rear surface of the cylinder head e2 such that the throttle bodies are coupled to the intake ports 20 which are arranged to open side by side in the rightward and leftward direction. The exhaust ports 21 for exhausting a combustion gas from the combustion chambers of the cylinders C, respectively, open on a front surface of the cylinder head e2 such that they are arranged side by side in the rightward and leftward direction. The exhaust ports 21 are coupled to exhaust manifolds (not shown), respectively.

An ignition plug 22 is disposed in the cylinder head e2 for each of the cylinders C and faces the combustion chamber through substantially a center of its ceiling portion. An ignition circuit 23 is coupled to an upper portion of the ignition plug 22 and an upper portion of the ignition circuit 23 penetrates the head cover e4. The ignition circuit 23 supplies a current to the ignition plug 22 at a predetermined ignition timing for each of the cylinders C, to ignite and combust an air-fuel mixture. The combustion causes the piston 3 to be pushed down, and a rotational force is transmitted to the crankshaft via the connecting rod (not shown).

A transmission case is integral with the rear portion of a crankcase e5 accommodating the crankshaft, etc. For example, a mesh gear transmission (not shown) is accommodated into the transmission case e5. An output shaft 24 of the transmission protrudes at a left side of the transmission case e5. A rotation from the output shaft 24 is transmitted to the rear wheel 3 via a chain 25 indicated by a virtual line. An oil pan e6 for reserving a lubricating oil is attached to a lower portion of the crankcase e5. A cylindrical oil filter 26 for filtering the oil protrudes forward from a front portion of the crankcase e5.

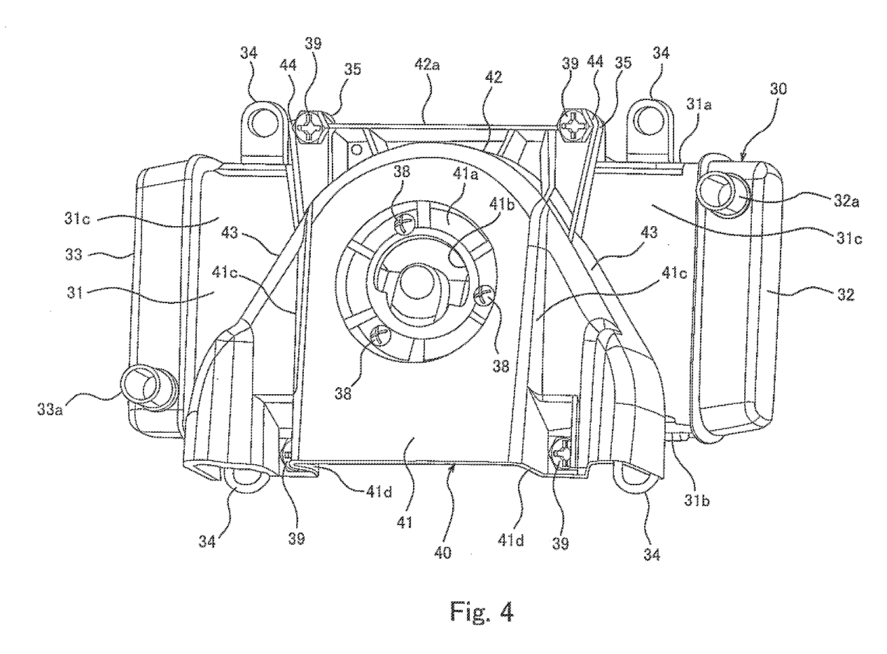

The engine E of the present embodiment is a water-cooled engine. The cylinder block e1 and the cylinder head e2 are cooled by using cooling water (cooling medium). A water pump 27 for circulating the cooling water is disposed at a left side of the crankcase e5. The water pump 27 is actuated by a driving power taken out of a driving power transmission path from the engine E to the transmission. The water pump 27 receives the cooling water introduced from a radiator 30 through a lower hose 28 and feeds with a pressure to the cylinder block e1 through a middle hose 29, as shown in FIG. 4.

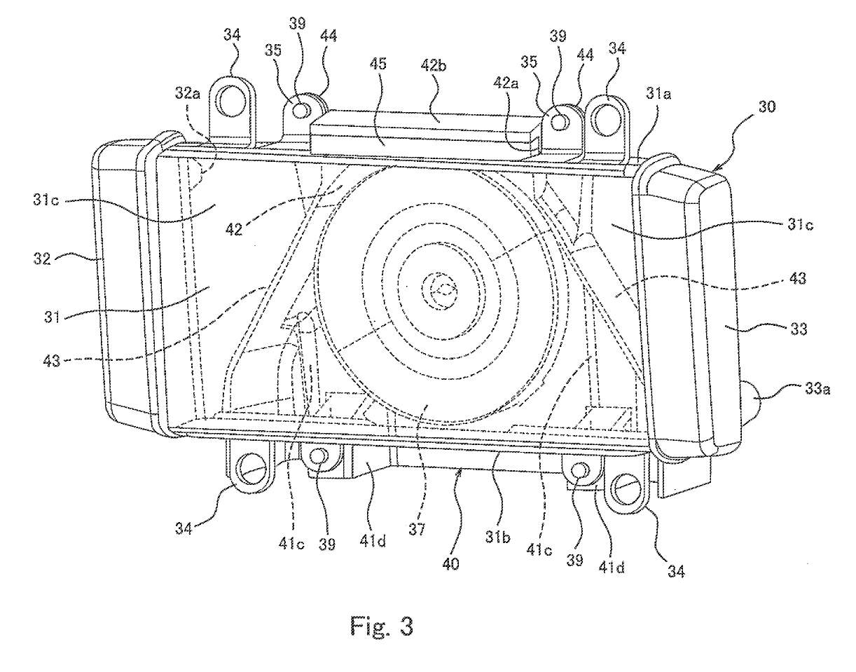

With reference to FIGS. 3 to 5, the radiator 30 is disposed such that its front surface is directed forward to allow ram air to travel therethrough in the forward and rearward direction. The radiator 30 is attached to hanger brackets 10d hanging from front portions of the right and left side frame members 10b of the main frame 10. The hanger brackets 10d join the cylinder head e2 of the engine E to the main frame 10. Thereby, a space is formed between the cylinder head e2 and the radiator 30. In this space, an electric fan 37 (see FIG. 3), and a shroud 40 are arranged.

The radiator 30 is inclined in a forward direction with a predetermined inclination angle of about 10 degrees such that its upper portion is located forward relative to its lower portion. Therefore, the ram air travels rearward and upward through an upper portion of a core 31 (see FIGS. 3 to 5) of the engine, to a region above the head cover e4 of the engine E. The cooling water exchanges heat with the ram air travelling through the core 31 and thereby radiates heat. The cooling water, the temperature of which has been lowered, is suctioned into the water pump 27 through the lower hose 28, as described above.

[Structure of Radiator Assembly]

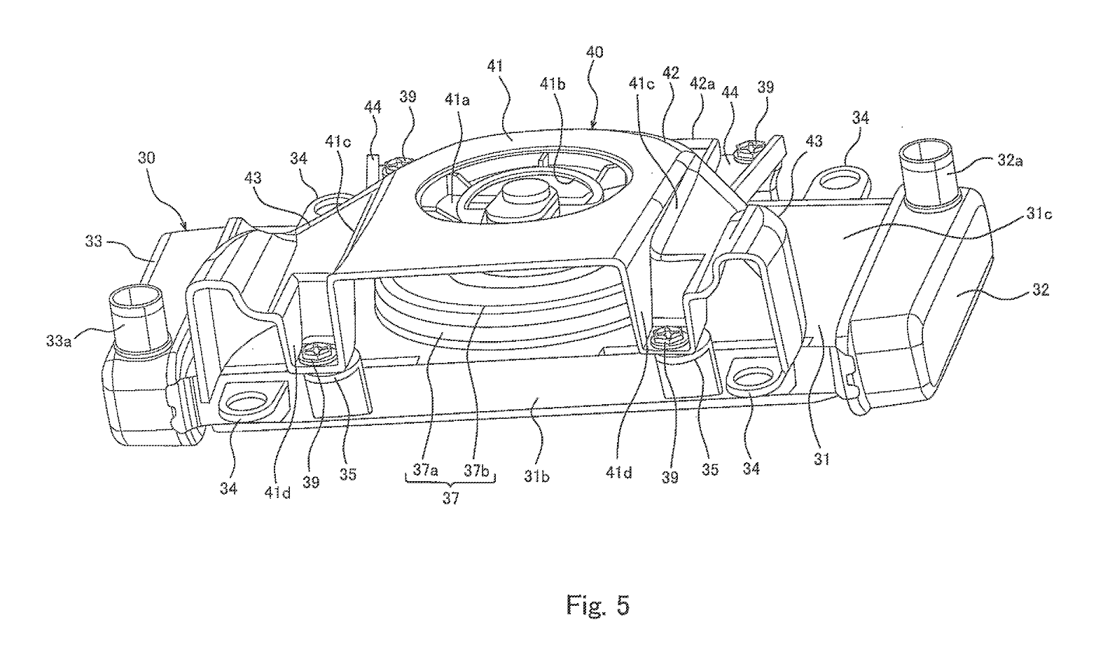

FIGS. 3 to 5 show an assembly of the radiator 30, the electric fan 37 and the shroud 40. FIG. 3 is a perspective view of the assembly, when viewed from the front. FIG. 4 is a perspective view of the assembly when viewed from the rear. FIG. 5 is a perspective view of the assembly when viewed from below.

As shown in FIGS. 3 to 5, the radiator 30 entirely has a rectangular shape elongated horizontally. A cooling water introduction tank 32 is attached to a right end of the radiator 30, while a cooling water discharge tank 33 is attached to a left end of the radiator 30. The cooling water introduction tank 32 is configured to introduce thereinto the cooling water with a relatively high temperature discharged from the cylinder head e2 of the engine E and guide it to the core 31. The cooling water introduction tank 32 is provided with a cylindrical cooling water inlet 32a protruding at an upper portion of a rear surface thereof. An upper hose (not shown) is coupled to the cooling water inlet 32a to introduce from the cylinder head e2 the high-temperature cooling water into the cooling water introduction tank 32.

The cooling water discharge tank 33 of the radiator 30 is configured to collect the cooling water, the temperature of which has been lowered, after travelling through the core 31, and feeds out the cooling water toward the engine E. The cooling water discharge tank 33 is provided with a cylindrical cooling water outlet 33a protruding at a lower portion of a rear surface thereof, and the lower hose 28 is coupled to the cylindrical cooling water outlet 33a. The core 31 located between the tanks 32 and 33 is provided with a plurality of tubes (not shown) extending in a rightward and leftward direction and arranged vertically. Between adjacent tubes, fins are provided. The cooling water flowing through the tubes from a right side to a left side exchanges heat with the ram air travelling through the core 31 in the forward and rearward direction.

An upper wall 31a of an elongate plate shape is provided at an upper end of the core 31 of the radiator 30, while a lower wall 31b of an elongate plate shape is provided at a lower end of the core 31. Mounting flanges 34 are provided in the vicinity of the right and left ends of the upper wall 31a and the lower wall 31b such that the mounting flanges 34 protrude upward and downward. The mounting flanges 34 are mounted to the hanger brackets 10d. Four mounting flanges 34 have a plate shape which is flat in the forward and rearward direction and have circular holes into which bolts (not shown) are inserted, respectively. In addition, mounting seats 35 of the shroud 40 are provided at the upper wall 31a and the lower wall 31b such that the mounting seats 35 are closer to the center than the mounting flanges 34.

In the motorcycle 1 of the present embodiment, as described above, the radiator 30 is disposed forward relative to the engine E, and the electric fan 37 is disposed between the radiator 30 and the engine E in the flow direction of the ram air such that it is located behind and in close proximity to the radiator 30. When the ram air is weak, for example, during low-speed driving, the electric fan 37 forcibly suctions out heated air from the radiator 30. For example, the electric fan 37 is an axial-flow electric fan configured in such a manner that an impeller 37a is rotated by an electric motor 37b, which is thin, to suction out the ram air in an axial direction of the impeller 37a. Alternatively, the impeller 37a of the electric fan 37 is not limited to the axial-flow electric fan, but may be, for example, a centrifugal electric fan.

The shroud 40 is provided to cover the electric fan 37 from behind, i.e., from a downstream side in the flow direction of the ram air travelling through the core 31, and to cover the electric fan 37 from above and from the right and left sides. The shroud 40 opens only in a downward direction. As shown in FIGS. 3 and 4, the shroud 40 has a rear wall portion 41 which entirely has a triangular shape and covers the electric fan 37 from behind, an upper wall portion 42 which extends forward from an upper edge of the rear wall portion 41 and is curved in a circular-arc shape to enclose an upper portion outer periphery of the electric fan 37, and a pair of right and left side wall portions 43 extending downward and outward from the right and left ends of the upper wall portion 42.

The shroud 40 entirely has a triangular shape, and the pair of right and left side wall portions 43 extends downward and outward to the right and to the left. This can gradually increase in the rightward and leftward direction, a cross-sectional area of a flow passage for guiding the heated air from the electric fan 37 in the downward direction. In the present embodiment, a dimension of the shroud 40 in the forward and rearward directions increases gradually from an upper side to a lower side, and therefore the cross-sectional area of the flow passage of the heated air increases gradually in the forward and rearward directions. Lower portions of the right and left side wall, portions 43, are curved gradually inward and then extend substantially vertically to allow the heated air to be blown out in the downward direction.

More specifically, the shroud 40 is made of resin. The rear wall portion 41, the upper wall portion 42 and the right and left side wall portions 43 have a unitary structure. As shown in FIGS. 4 and 5, a circular seat surface 41a protrudes forward from a substantially center portion of the rear wall portion 41. A rear surface of the electric motor 37b of the electric fan 37 is joined to the seat surface 41a. An opening portion 41b is formed on the center portion of the seat surface 41a. A projection of a rear portion of the electric motor 37b is accommodated into the opening portion 41b. In addition, through-holes (not shown) are formed on the center portion of the seat surface 41a. Three screws 38 are inserted into the through-holes, respectively, to fasten the electric motor 37b. In the present embodiment, the electric fan 37 is mounted to the shroud 40 in such a manner that the electric motor 37b is fastened to the rear wall portion 41 of the shroud 40.

The rear wall portion 41 of the shroud 40 is provided with band-shaped stepped (protruding) portions 41c extending vertically from the seat surface 41a of the center portion thereof, such that the stepped (protruding) portions 41c are apart from each other in the rightward and leftward direction. As shown in FIG. 4, when viewed from the rear, the stepped (protruding) portions 41c are band-shaped grooves which are elongated vertically. By comparison, as shown in FIG. 5, when viewed from below, the stepped (protruding) portions 41c protrude forward from the front surface of the rear wall portion 41. A distance between the stepped (protruding) portions 41c in the rightward and leftward direction is set slightly greater than a diameter of the impeller 37a. The stepped (protruding) portions 41c are apart from right and left ends of the impeller 37a, respectively.

Mounting leg portions 41d protrude forward from lower end portions of the stepped (protruding) portions 41c, respectively. The mounting leg portions 41d have substantially U-shaped cross-sections which open in the downward direction. Front end surfaces of the mounting leg portions 41d are joined to the mounting seats 35 provided at the lower wall 31b of the core 31 of the radiator 30 and fastened to them by means of bolts 39, respectively. As a result, a lower opening of the shroud 40 is divided into a main opening portion between the right and left mounting leg portions 41d and sub-opening portions between the mounting leg portions 41d and the side wall portions 43 of the shroud 40.

In an upper portion of the shroud 40 at which the right and left ends of the upper wall portion 42 are connected to the right and left side wall portions 43, a pair of right and left mounting arm portions 44 extend upward. The right and left mounting arm portions 44 are joined to the mounting seats 35 provided at the upper wall 31a of the core 31 of the radiator 30 and fastened thereto by means of bolts 39, respectively. An extending portion 42a extending upward is provided at the upper surface of the upper wall portion 42 to connect the right and left mounting arm portions 44 to each other. A bent portion 42b of which is bent forward is provided at an upper edge of the extending portion 42a.

As shown in FIG. 4, the extending portion 42a has a rib on a rear surface thereof. As shown in FIG. 3, a seal member 45 is provided on a front surface of the extending portion 42a. The seal member 45 is formed by molding a sponge or the like, in a rectangular column shape which is elongated horizontally. The seal member 45 closes a space between the bent portion 42b and the upper wall 31a of the core 31 of the radiator 30. That is, the seal member 45 seals a space formed between the upper wall portion 42 of the shroud 40 sandwiched between the right and left mounting arm portions 44, and the core 31 of the radiator 30, thereby preventing the heated air inside of the shroud 40 from leaking upward.

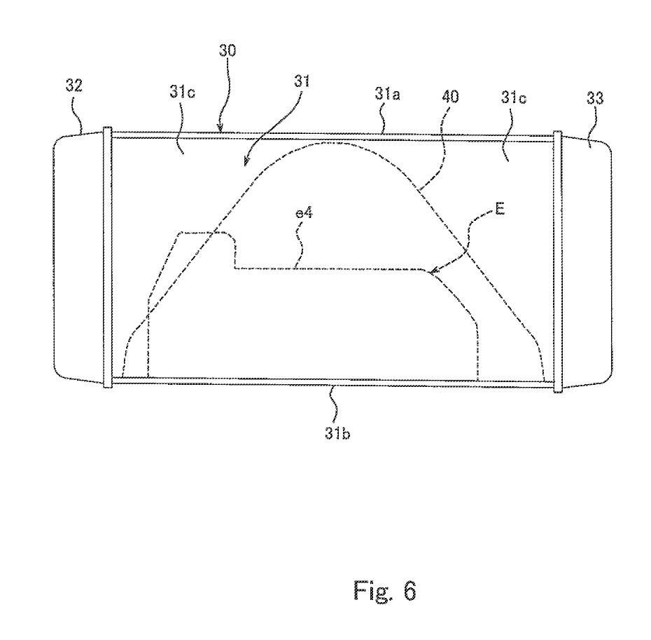

In a state in which the shroud 40 entirely having the triangular shape is mounted to the rear surface of the radiator 30 which is elongated horizontally, a region which is about ⅓ of the core 31 and is at a center portion in the rightward and leftward directions is covered with the shroud 40. In addition, triangular regions which are about ⅓ of the core 31, are right and left portions of the core 31, and are at a lower side of the core 31, are covered with the shroud 40. As a result, as schematically shown in FIG. 6, when the core 31 is viewed from a direction (direction orthogonal to the front surface of the core 31) in which the ram air travels through the core 31, triangular regions 31c (ram air passage regions) through which the ram air passes easily are formed at right and left sides of the shroud 40. The ram air passage regions 31c are formed in a right upper portion and a left upper portion of the core 31, respectively.

As shown in FIG. 1, the front wheel 2 is located at a center of the vehicle body in the rightward and leftward direction, in front of the radiator 30. The ram air travels through an upper side of the front wheel 2 and right and left sides thereof, and into the core 31 of the radiator 30. Therefore, the ram air can easily travel through the ram air passage regions 31c in the right and left portions of the upper portion of the core 31 of the radiator 30.

Moreover, since the ram air travels upward in the rearward direction through the core 31 of the radiator 30 which is inclined forward, the ram air which has traveled through the core 31 flows smoothly through a region above the engine E and regions at right and left sides of the engine E, because a greater part of the ram air passage regions 31c do not overlap with the head cover e4 of the engine E located behind them. The ram air passage regions 31c may be designed so that at least a half portion thereof does not overlap with the engine E.

### Advantages

It is assumed that the motorcycle 1 of the present embodiment is compelled to drive at a low speed, for example, in traffic congestion, a temperature of the cooling water of the engine E increases and the electric fan 37 is actuated. The heated air is suctioned out of the core 31 of the radiator 30 by the rotation of the impeller 37a. The suctioned heated air is fed in the rearward relative to the impeller 37a, then flows in the downward direction through a space between the electric fan 37 and the rear wall portion 41 of the shroud 40, and then blows out of the shroud 40 in the downward direction as indicated by an arrow in FIG. 2.

When the temperature of the cooling water is not high, the impeller 37a rotates at a low speed, and an amount of the heated air fed out of the impeller 37a is not so large. The heated air is guided to the right and left stepped portions 41c of the rear wall portion 41 of the shroud 40. The heated air flows downward straightly between the stepped portions 41c, and blows out in the downward direction through the main opening of the shroud 40. This allows the heated air to blow out in the downward direction at an adequate speed although its amount is small. As indicated by an arrow of FIG. 2, the heated air flows from forward relative to the engine to a region below the engine E and then flows in the rearward direction.

On the other hand, when the temperature of the cooling water increases, the impeller 37a rotates at a high speed, and an amount of the heated air fed out of the impeller 37a increases, a portion of the heated air flows over the stepped portions 41c and spreads to the right and to the left. Then, the heated air flows in the downward direction along the right and left side walls 43 of the shroud 40, and blows out through the sub-openings of the shroud 40. That is, a cross-sectional area of the flow passage for guiding the heated air in the downward direction can be ensured, and a resistance to the operation of the electric fan 37 is not so great. In addition, since the amount of the heated air is large, the heated air blows out of the shroud 40 in the downward direction at a high speed even though the heated air spreads to the right and to the left. Like the above case, the heated air flows in the rearward direction in the region below the engine E.

During low-speed driving of the motorcycle 1 when the ram air is slow, the heated air is suctioned out of the radiator 30 by the operation of the electric fan 37, blows out of the shroud 40 in the downward direction, and flows from the region below the engine E to the region rearward relative to the engine E. This makes it possible to avoid the driver or the passenger from being exposed to the heated air. Thus, the driver or the passenger does not feel discomfort due to the heated air The heated air does not substantially stay inside of the full cowling 6 of the motorcycle 1 of the present embodiment, and will not negatively affect the components built into the motorcycle 1.

By comparison, during high-speed driving of the motorcycle 1 when the ram air is fast, the radiator 30 receives the ram air at a high speed. The ram air travels from the upper side and the right and left sides of the front wheel 2, through the right and left ram air passage regions 31c in the upper portion of the core 31 of the radiator 30, and then through a region above the engine E and regions at right and left sides of the engine E. Therefore, an air flow resistance which would be caused by the shroud 40 does not increase so much even when the ram air becomes fast.

### Other Embodiment

The air guide structure of the radiator of the present invention is not limited to the present embodiment, and can be changed, added or deleted without changing the scope of the invention. Although in the present embodiment, the radiator 30 is positioned forward relative to the engine E to allow the ram air to travel through the engine E in the forward and rearward direction, the radiator 30 may be disposed laterally or rearward relative to the engine E, or may be configured such that the ram air travels through the engine E in the rightward and leftward direction.

It is not necessary to provide the ram air passage regions 31c of the core 31 of the radiator 30 at the right and left portions of the upper portion of the core 31. For example, the electric fan 37 and the shroud 40 may be positioned at one of right and left sides of the core 31, and the ram air passage regions 31c may be positioned at the other side. The core 31 may be configured not to be elongated horizontally. For example, the electric fan 37 and the shroud 40 may be positioned in a center portion of the core 31 which is elongated vertically, and the ram air passage regions 31c may be provided at upper and lower sides, respectively. Or, the electric fan 37 and the shroud 40 may be positioned at one of upper and lower sides in the core 31 which is elongated vertically, and the ram air passage regions 31c may be provided at the other side.

Although in the present embodiment, the electric fan 37 attached to the shroud 40 is mounted to the radiator 30, a mounting (support) member for mounting (supporting) the electric fan 37 to the radiator 30 may be additionally provided.

A specific structure of the shroud 40 is not limited to the above embodiment. Although the right and left side walls 43 of the shroud 40 extend downward and outward to the right and to the left, respectively, they may extend substantially straightly downward, or extend downward such that a distance between them decreases in the downward direction.

The radiator 30 need not be inclined in the forward direction, but may extend substantially straightly vertically or may be inclined in the rearward direction. Or, the radiator 30 may be inclined to the right or to the left.

Although in the present embodiment, the inline two-cylinder engine E is mounted in the motorcycle 1, for example, an engine of a single cylinder, an engine of three to six cylinders, a horizontally opposed engine or a V-type engine may be mounted in the motorcycle 1. Or, an electric motor may be built into the motorcycle 1 as a driving power source in addition to or instead of the engine E. Moreover, the present invention is applicable to, for example, an all terrain vehicle as well as the motorcycle.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An air guide structure of a radiator which is built into a straddle vehicle and exchanges heat between a cooling medium of a driving power source and ram air to release heat from the cooling medium, the air guide structure comprising:
an electric fan provided at a core of the radiator such that the electric fan is disposed in close proximity to the core of the radiator at a downstream side of the radiator in a flow direction of the ram air; and
a shroud provided to cover the electric fan from the downstream side, and cover the electric fan from above and from both lateral sides, the shroud being open in a downward direction;
wherein the core of the radiator is provided with a ram air passage region outside of a portion of the core which is covered with the shroud when viewed in the flow direction of the ram air, the ram air travelling through the ram air passage region.

2. The air guide structure of the radiator according to claim 1,
wherein the electric fan is mounted to the shroud.

3. The air guide structure of the radiator according to claim 1,
wherein the radiator is disposed forward relative to the driving power source to allow the ram air to travel through the radiator in a forward and rearward direction of the straddle vehicle; and
wherein at least a half portion of the ram air passage region of the core of the radiator does not overlap with the driving power source when viewed in the flow direction of the ram air.

4. The air guide structure of the radiator according to claim 3,
wherein the radiator is inclined in a forward direction such that its upper portion is forward relative to its lower portion.

5. The air guide structure of the radiator according to claim 3,
wherein the radiator has a rectangular shape which is elongated in a rightward and leftward direction of the straddle vehicle; and
wherein the shroud has in an upper portion thereof a circular-arc upper wall portion enclosing a periphery of the electric fan, a pair of right and left side walls extending from right and left ends of the upper wall portion such that the side wall portions extend downward and outward in the rightward and leftward direction, and a rear wall portion covering the electric fan from a rear.

6. The air guide structure of the radiator according to claim 3,
wherein the shroud has a rear wall portion covering the electric fan from a rear; and
wherein protruding portions protruding forward from the rear wall portion extend vertically to be apart from the right and left ends of the electric fan such that the protruding portions are apart from each other in the rightward and leftward direction when viewed in the flow direction of the ram air.

7. The air guide structure of the radiator according to claim 3,
wherein a dimension of the shroud in the forward and rearward direction increases gradually from an upper side to a lower side.

8. The air guide structure of the radiator according to claim 1, comprising:
a seal member provided between an upper portion of the shroud and the radiator.

9. An air guide structure of a radiator which is built into a straddle vehicle, exchanges heat between a cooling medium of a driving power source and ram air to release heat from the cooling medium, the air guide structure comprising:
a guide member which is disposed rearward in a flow direction of the ram air relative to a heat exchange section of the radiator and guides the ram air in an outward direction of the vehicle after the ram air has passed through the heat exchange section of the radiator.

10. The air guide structure of the radiator according to claim 9, further comprising:
a fan which is disposed rearward in the flow direction of the ram air relative to the heat exchange section of the radiator and causes the ram air to pass through the heat exchange section such that the ram air is guided from forward of the heat exchange section to rearward of the heat exchange section;
wherein the guide member guides the ram air flowing out of the fan, in the outward direction of the vehicle.

11. The air guide structure of the radiator according to claim 9,
wherein the guide member has an opposed surface positioned rearward in the flow direction of the ram air so as to face the heat exchange section of the radiator and a guide surface extending in a forward and rearward direction so as to surround the opposed surface; the opposed surface and the guide surface forming a guide surface for guiding the ram air; and
wherein the opposed surface is inclined in a forward direction with respect to a vertical direction.

12. The air guide structure of the radiator according to claim 9,
wherein the guide member guides the ram air in a downward direction.

13. The air guide structure of the radiator according to claim 9,
wherein the radiator and the guide member are disposed forward in the flow direction of the ram air relative to a driving power source.

14. The air guide structure of the radiator according to claim 13,
wherein the driving power source is an engine including a cylinder block;
wherein the cylinder block and the radiator are inclined in a forward direction; and
wherein the guide member guides the ram air along a direction in which the cylinder block and the radiator are inclined.
